(19) United States
(12) Patent Application Publication
(10) Pub. No.: US 2007/0075061 A1
(43) Pub. Date: Apr. 5, 2007

(54) Method and apparatus for adjusting static attitude of magnetic head

(75) Inventors: Osamu Shindo, Tokyo (JP); Toru Mizuno, Tokyo (JP); Hitoshi Nakayama, Tokyo (JP); Shinji Atsuzawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/542,377

(22) Filed: Oct. 4, 2006

(30) Foreign Application Priority Data
Oct. 5, 2005 (JP) 2005-292994

(51) Int. Cl. B23K 26/02; B21J 5/06

(52) U.S. Cl. 219/121.83; 219/121.85; 219/153

(57) ABSTRACT

Provided is a method for adjusting static attitude of a magnetic head attached to a flexure that is disposed near a free end of a head support. The free end is a distal end in a longitudinal direction of the head support. The method includes generating an adjustment condition by analyzing an image signal obtained from images of the magnetic head, the images being picked up with at least two image pickup units; bending the flexure for static attitude adjustment based on the adjustment condition; and irradiating a laser beam to a bent area of the flexure.

### BACKGROUND OF THE INVENTION

1. Field of the Invention

The present invention relates to a method and apparatus for adjusting static attitude of a magnetic head on a support.

2. Description of the Related Art

It is an essential requirement of a floating-type magnetic head unit to hold at a higher accuracy the static attitude of a magnetic head supported with a head support for achieving high density recording and reproducing. The static attitude angles of the magnetic head unit include a pitch angle and a roll angle.

However, the magnetic head unit is generally configured to have the magnetic head bonded to one end of the head support (or suspension) through an adhesive, which may cause displacement from a desired static attitude.

Since the magnetic head unit is manufactured by mounting the magnetic head, which is an expensive component manufactured through elaborate processes, on the head support, which is also an expensive high-precision component, it is not permitted to discard the assembled magnetic head unit as a defective product merely on the grounds that the static attitude angle of the magnetic head does not fall within a given range.

In order to correct the displacement of the static attitude, there has been developed an adjusting means which applies a mechanical pressure with the use of a pressing jig. According to this static attitude adjusting method using the pressing jig, a flexure on which the magnetic head is mounted is bent by pressure, thereby adjusting the static attitude of the magnetic head.

After being bent by the mechanical pressure, however, the flexure tends to be sprung back by its restoring force. This means that the flexure has to be bent more than necessary to merely attain the desired static attitude.

When the flexure is bent largely, a gap may be created between the flexure and a projection (or dimple) through which a load is applied from a load beam to the flexure, resulting in the occurrence of so-called dimple floating. The dimple floating inhibits the load beam from applying a load onto the flexure, thus deteriorating the floating characteristic of the magnetic head.

As a magnetic head support mechanism, furthermore, there have been developed a head gimbal assembly (hereinafter referred to as HGA), a head arm assembly (hereinafter referred to as HAA) with an HGA attached to an arm, and a head stack assembly (hereinafter referred to as HSA) with a plurality of HAAs stacked each other.

Here, since the HSA is produced by assembling a pair of HAAs with their magnetic heads facing each other, the magnetic heads are hidden behind the gimbals, inhibiting detection of attitude angles of the magnetic head and irradiation of a laser beam to the magnetic head.

As a means for solving the above problem, Japanese Unexamined Patent Application Publication Nos. 2001-357644 & 2001-357645 disclose a technology of keeping the flexure bent at an angle close to the initial bending angle, wherein after the flexure or load beam is bent for static attitude adjustment, stress is relieved by irradiating a laser beam to the bent area.

This prior art technology has an excellent effect that a significant change in static attitude can be obtained from bending the head support at a small angle. However, it fails to explicitly disclose a means for solving the problem inherent in the HSA.

### SUMMARY OF THE INVENTION

It is an object of the present invention to provide an improved method and apparatus for adjusting static attitude of a magnetic head, which enables automatic static attitude adjustment even in an HSA.

In order to achieve the above object, the present invention provides a method for adjusting static attitude of a magnetic head attached to a flexure that is disposed near a free end of a head support, the free end being a distal end in a longitudinal direction of the head support, the method comprising:

generating an adjustment condition by analyzing an image signal obtained from images of the magnetic head, the images being picked up with at least two image pickup units;

bending the flexure for static attitude adjustment based on the adjustment condition; and

irradiating a laser beam to a bent area of the flexure.

According to the static attitude adjusting method of the present invention, first of all, an adjustment condition is generated by analyzing an image signal obtained from images of the magnetic head, wherein the images are picked up with at least two image pickup units. The advantage of obtaining an image signal by picking up images of the magnetic head is that the attitude angle data of the magnetic head (which is a measuring object) can be obtained by picking up images from arbitrary directions using an image pickup means such as a CCD camera. For example, even in an HSA where the magnetic head to be measured is hidden behind the gimbal, an image signal of the magnetic head can easily be generated by arbitrarily placing CCD cameras, e.g., at front and lateral sides of HSA, and then analyzed to obtain the attitude angle data. It is also possible to replace the CCD camera by a laser autocollimator, but the laser autocollimator, which has to receive reflected light, does not have a high degree of positional flexibility as compared with the CCD camera.

Then, based on an adjustment condition generated by analyzing the obtained image signal, the flexure is bent for static attitude adjustment, followed by irradiating a laser beam to the bent area of the flexure.

When the flexure is bent for static attitude adjustment, a stress corresponding to the bending is generated in the flexure. According to the present invention, the bent area of the flexure is then exposed to the laser beam. In the laser-irradiated bent area, consequently, the stress can be relieved by heat due to the irradiation of the laser beam. As a result, the restoring effect of the flexure decreases in the laser-irradiated area, keeping the flexure bent at an angle close to the initial bending angle. This means that the flexure can be kept at a desired bending angle even if the initial bending angle is small. Therefore, a significant change in static attitude can be obtained from bending the flexure at a small angle.

As a method for picking up images of the magnetic head, which serves as a basis for static attitude adjustment, the followings are possible.
(a) The adjustment condition is generated by analyzing an image signal obtained from two images of the magnetic head,

wherein one image is picked up from a front side facing the free end, and another image is picked up from a lateral side in a direction approximately perpendicular to the longitudinal direction.
(b) The adjustment condition is generated by analyzing an image signal from three images of the magnetic head,

wherein one image is picked up from a front side facing the free end, and the other two images are picked up from both lateral sides in a direction approximately perpendicular to the longitudinal direction.
(c) The adjustment condition is generated by analyzing an image signal from two images of the magnetic head,

wherein the two images are picked up from both lateral sides in a direction approximately perpendicular to the longitudinal direction.

As a method for determining a static attitude angle, furthermore, it may be effective to determine a static attitude angle from an angle which an air bearing surface (hereinafter referred to as ABS) of the magnetic head makes with a reference line indicating zero inclination angle of the ABS. More specifically, a static attitude angle may be determined from a difference in distance between the reference line and two edges of the ABS. The reference line may be an image signal and may be optionally displayed on a screen.

The above static attitude adjusting method may be performed using an apparatus according to another aspect of the present invention. This apparatus comprises:

an adjusting unit for bending the flexure;

a laser emitter unit for irradiating a laser beam to a bent area of the flexure;

at least two image pickup units for picking up images of the magnetic head to generate an image signal; and

a computer system for analyzing the image signal supplied from the image pickup units to generate an adjustment condition, enabling the adjusting unit to bend the flexure based on the adjustment condition supplied from the computer system.

It is apparent that the static attitude adjusting method according to the present invention can be automatically performed using this static attitude adjusting apparatus. Moreover, the components constituting the apparatus may be configured as in the following preferred embodiments.

According to one embodiment, the image pickup units may include first and second image pickup units. The first image pickup unit may be located to pick up an image of the magnetic head from a front side facing the free end, and the second image pickup unit may be located to pick up an image of the magnetic head from a lateral side in a direction approximately perpendicular to the longitudinal direction.

With this configuration, the roll angle data of the magnetic head can be obtained from the first image pickup unit, while the pitch angle data can be obtained from the second image pickup unit. Accordingly, an image signal obtained by the image pickup units can be utilized for adjusting the roll and pitch angles.

According to another embodiment, the image pickup units may further include a third image pickup unit. The third image pickup unit may be located opposite to the second image pickup unit to pick up an image of the magnetic head from another lateral side. With this configuration, the pitch angle data can be obtained from both the second and third image pickup units, whereby the pitch angle adjustment can be performed with a high degree of precision.

According to still another embodiment, images of the magnetic head may be picked up only from both lateral sides in a direction approximately perpendicular to the longitudinal direction by using two image pickup units (i.e., the second and third image pickup units).

According to still another embodiment, the computer system may include a CPU and a memory unit in which adjustment conditions corresponding to static attitude angles of the magnetic head are previously ranked and memorized. The CPU may be configured to retrieve from the memory unit a particular adjustment condition corresponding to a measured value supplied from the image pickup units and supply the retrieved adjustment condition to the adjusting unit.

It is apparent that this computer system, which provides a static attitude adjusting system mainly of a CPU, enables automatic adjustment of the static attitude of the magnetic head with a high degree of repeatability.

The computer system may be configured to determine a static attitude angle from an angle which an ABS of the magnetic head makes with a reference line indicating zero inclination angle of the ABS.

More specifically, the computer system may be configured to determine a static attitude angle from a difference in distance between the reference line and two edges of the air bearing surface.

The adjusting unit may include a plurality of movable adjustment pins whose distal ends are positioned to be able to be pressed against surfaces of the flexure. With this adjusting unit, the pitch and roll angles can easily be adjusted by changing positions and thrust distances of the adjustment pins. Here, the adjustment conditions may include contact positions and thrust distances of the adjustment pins against the flexure and laser irradiation positions on the flexure.

Preferably, the adjustment pins are disposed at a given angle with respect to the surfaces of the flexure. With this arrangement, even in an HSA, the adjustment pins can be brought into contact with the flexure for bending. In addition, mutual interference, e.g., contact or overlap of the adjustment pins, can be avoided even if the magnetic head and the flexure are miniaturized.

As has been described hereinabove, the present invention provides a method and apparatus for adjusting static attitude of a magnetic head, which enables automatic static attitude adjustment even in an HSA.

The present invention will be more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a diagram showing configuration of a static attitude adjusting apparatus employed for performing a static attitude adjusting method according to one embodiment of the present invention;

FIG. 2 is a diagram showing arrangement of image pickup units employed in the static attitude adjusting apparatus;

FIG. 3 is a diagram showing an image picked up by a first image pickup unit;

FIG. 4 is a diagram showing an image picked up by a second image pickup unit;

FIG. 5 is a diagram showing an image picked up by a third image pickup unit;

FIG. 6 is a diagram showing arrangement of pins of an adjusting unit employed in the static attitude adjusting apparatus;

FIG. 7 is a diagram showing arrangement of laser emitter units employed in the static attitude adjusting apparatus;

FIG. 8 is a flow chart of a static attitude adjusting method according to one embodiment of the present invention;

FIG. 9 is a diagram showing a roll angle adjusting process utilizing an image picked up by the first image pickup unit;

FIG. 10 is a diagram showing a pitch angle adjusting process utilizing an image picked up by the second image pickup unit;

FIG. 11 is a diagram showing a pitch angle adjusting process utilizing an image picked up by the third image pickup unit;

FIG. 12 is a diagram showing a roll angle adjusting process by the second and third image pickup units;

FIG. 13 is a diagram showing an idea of how adjustment conditions will be ranked corresponding to static attitude angles;

FIG. 14 is a diagram showing a pitch angle adjusting process by the adjusting unit;

FIG. 15 is a diagram showing another pitch angle adjusting process by the adjusting unit;

FIG. 16 is a diagram showing a roll angle adjusting process by the adjusting unit;

FIG. 17 is a diagram showing another roll angle adjusting process by the adjusting unit;

FIG. 18 is a diagram showing laser irradiation positions on a flexure;

FIG. 19 is a plan view showing a concrete structure of a static attitude adjusting apparatus according to one embodiment of the present invention;

FIG. 20 is a front view of the static attitude adjusting apparatus shown in FIG. 19; and

FIG. 21 is a side view of the static attitude adjusting apparatus shown in FIGS. 19 and 20.

### DESCRIPTION OF THE PREFERRED EMBODIMENTS

<Adjusting Apparatus>

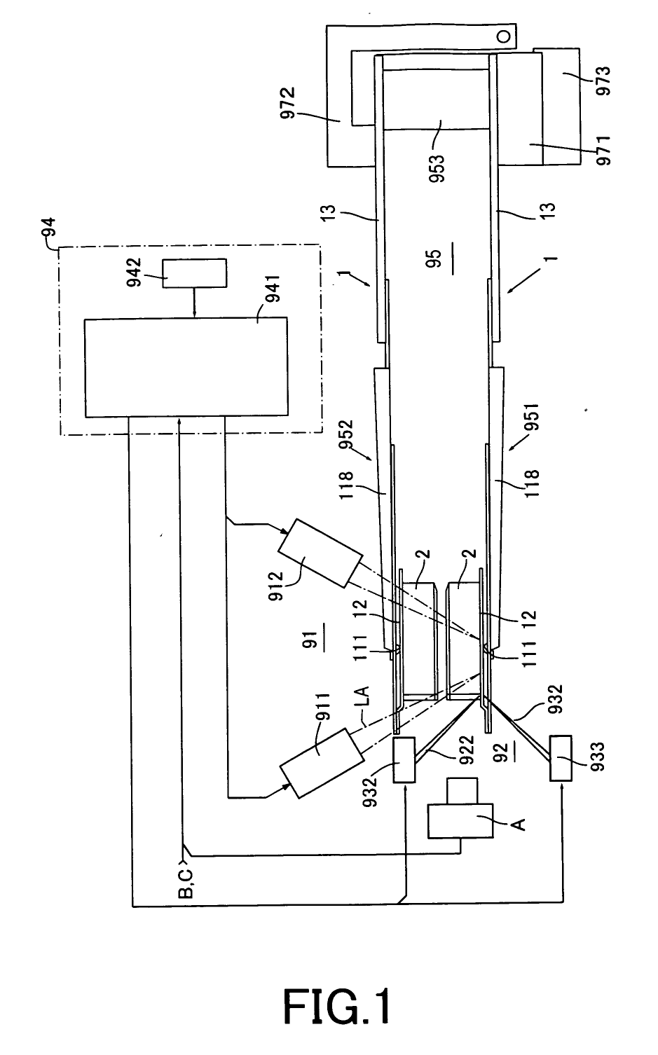

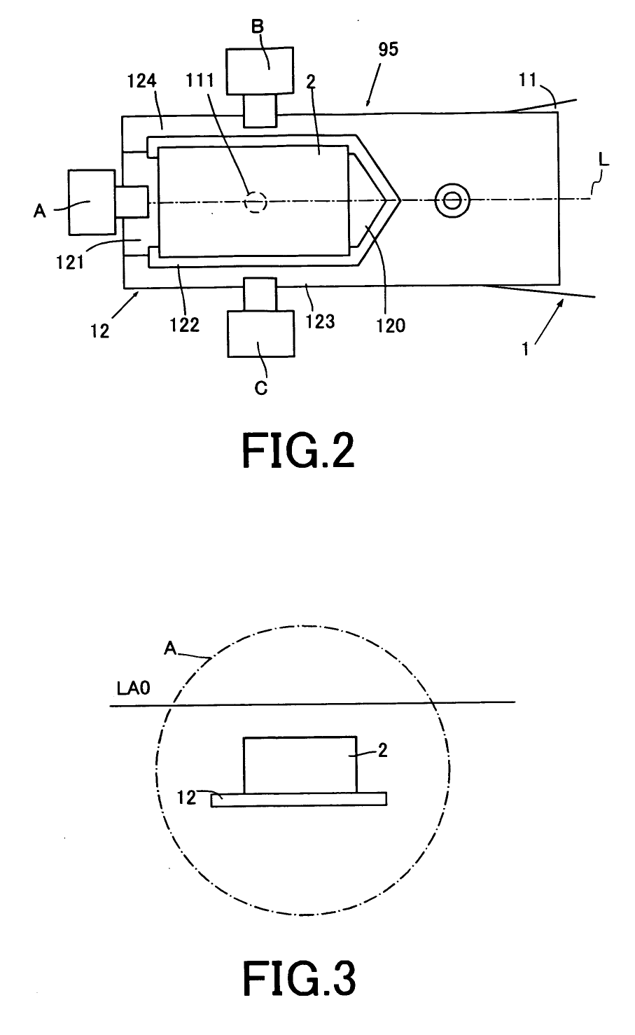

FIG. 1 is a diagram showing configuration of a static attitude adjusting apparatus employed for performing a static attitude adjusting method according to one embodiment of the present invention, and FIG. 2 is a plan view showing a magnetic head unit to be adjusted by a static attitude adjusting method according to one embodiment of the present invention. The illustrated static attitude adjusting apparatus is applicable to static attitude adjustment in an HSA.

An HSA 95 is a stack of two HAAs 951, 952 each comprising a head support 1 and a magnetic head 2. The head support 1 comprises a load beam 11, a flexure 12, and an arm 13. The load beam 11 has a projection 111 located close to a free end thereof and on a longitudinal axis L thereof. At both lateral sides, the illustrated load beam 11 has two bent portions 118 to increase rigidity (see FIG. 1).

The flexure 12 is formed from a thin leaf spring and subjected to a pressing load from the projection 111 with one side of the flexure 12 attached to one side of the load beam 11 where the projection 111 is located. The magnetic head 2 is attached to the other side of the flexure 12. The flexure 12 is secured to the projection 111 side of the load beam 11 by spot welding or the like. The spot welding may be replaced by swaging. The flexure 12 has a tongue portion 120 in the center thereof. At one end, the tongue portion 120 is joined to a lateral frame portion 121 of the flexure 12. Both ends of the lateral frame portion 121 are connected to longitudinal frame portions 123, 124 of the flexure 12. A groove 122 is provided between the tongue portion 120 and the longitudinal frame portions 123, 124, extending around the tongue portion 120. The magnetic head 2 is bonded to one side of the tongue portion 120 through an adhesive or the like to be in spring contact with the projection 111.

The HAAs 951, 952 are connected to each other through a connection member 953 with the ABSs of the magnetic heads 2 facing each other. A plurality of such HSAs 95 may be arranged at intervals on a workpiece pallet 971. Then, the workpiece pallet 971 may be mounted on a conveying jig 973 and held against the conveying jig 973 by a holding jig 972.

The static attitude adjusting apparatus illustrated in FIG. 1 is employed for adjusting the static attitude of the magnetic head 2 in the above HSA. The static attitude angles include a pitch angle and a roll angle. The pitch angle refers to an angle between the magnetic head 2 and a reference line parallel to the longitudinal axis L of the load beam 11 (see FIG. 2); the roll angle refers to an angle about the longitudinal axis L. The static attitude angles may vary depending on the assembled position of the magnetic head 2 relative to the head support 1, the bending of the head support 1, and other conditions. The static attitude adjusting method and apparatus of the present invention have been devised to adjust the static attitude to desired values.

To this end, the static attitude adjusting apparatus according to one embodiment of the present invention comprises image pickup units A to C, an adjusting unit 92, laser emitter units 911, 912, and a computer system 94. Here will be described the configuration and functions thereof. Image Pickup Unit The image pickup units A to C include a first image pickup unit A, a second image pickup unit B, and a third image pickup unit C. FIGS. 3 to 5 are diagrams schematically showing images picked up by the first image pickup unit A, the second image pickup unit B, and the third image pickup unit C. These drawings will be explained with the arrangement of FIG. 2 in mind. At first, the first image pickup unit A picks up an image of the magnetic head 2 from a front side facing the free end of the head support 1 in the direction of the longitudinal axis L, as illustrated in FIG. 2. This picked-up image is illustrated in FIG. 3. The picked-up image includes a reference line LAO indicating zero roll angle of the ABS of the magnetic head 2.

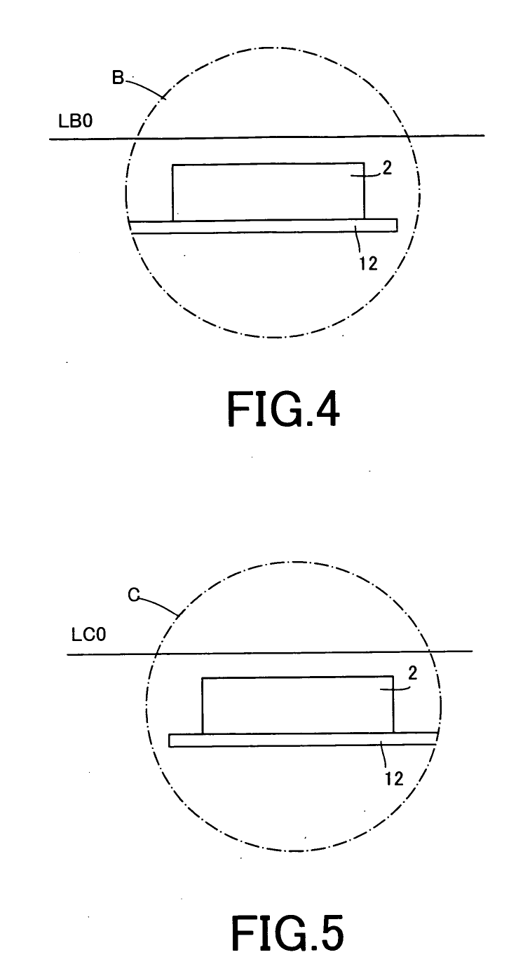

The second image pickup unit B picks up an image of the magnetic head 2 from a lateral side in a direction approximately perpendicular to the longitudinal axis L, as illustrated in FIG. 2. This picked-up image is illustrated in FIG. 4. The picked-up image includes a reference line LBO indicating zero pitch angle of the ABS of the magnetic head 2.

The third image pickup unit C picks up an image of the magnetic head 2 from a side opposite to the second image pickup unit B, as illustrated in FIG. 2. This picked-up image is horizontally reversed from the picked-up image of the second image pickup unit C, as illustrated in FIG. 5. The picked-up image includes a reference line LCO indicating zero pitch angle of the ABS of the magnetic head 2.

With the above arrangement of the image pickup units A to C, the roll angle data of the magnetic head 2 can be obtained by the first image pickup unit A, while the pitch angle data can be obtained by the second and third image pickup units B, C. Accordingly, an image signal obtained from the image pickup units can be utilized for adjusting the roll and pitch angles.

The pitch angle can be measured only with the second image pickup unit B, but the illustrated embodiment includes the third image pickup unit C in addition to the second image pickup unit B. With this configuration, the pitch angle data can be obtained from both the second and third image pickup units B, C, whereby the pitch angle adjustment can be performed with a high degree of precision.

According to another embodiment, the roll angle may be calculated by detecting the positions of the edges of the magnetic head with both the second and third image pickup units B, C. In this case, the first image pickup unit A for roll angle measurement may be omitted.

<Adjusting Unit>

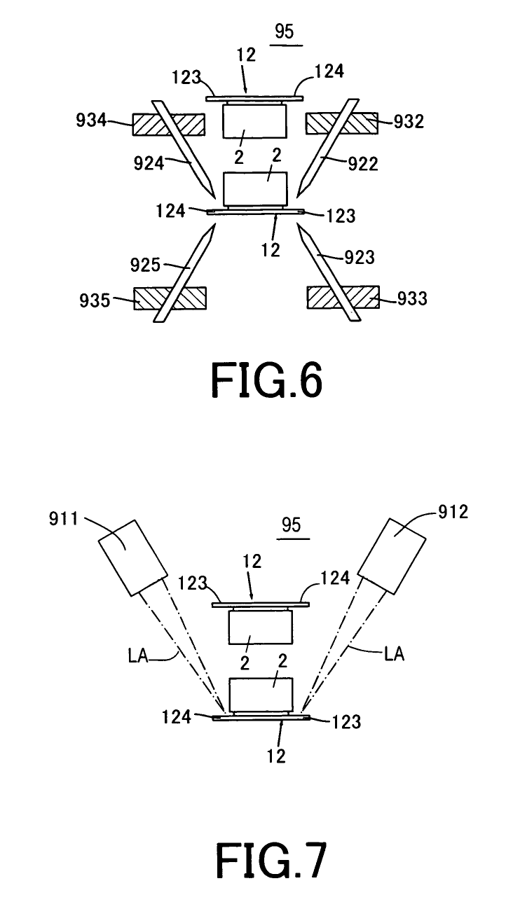

FIG. 6 is a diagram showing one embodiment of the adjusting unit 92. Referring to FIG. 6, the adjusting unit 92 has a plurality of movable adjustment pins whose distal ends can be pressed against the surfaces of the flexure 12. In this embodiment, the adjusting unit 92 has four adjustment pins 922 to 925 and four driving units 932 to 935. The adjustment pins 922 to 925 are movable pins which will be moved linearly by the driving units 932 to 935, respectively, with their distal ends positioned to be able to come into contact with the longitudinal frame portions 123, 124 of the flexure 12. The adjustment pins 922, 924 are located on one side of the flexure 12 (where the magnetic head 2 is attached), while the adjustment pins 923 and 925 are located on the other side of the flexure 12. In the illustrated embodiment, the adjustment pin 922 is opposed to the adjustment pin 923, and the adjustment pin 924 is opposed to the adjustment pin 925. However, the adjustment pins (922, 923 or 924, 925) of each pair may be arranged in different locations without being opposed to each other.

Preferably, the adjustment pins 922 to 925 are inclined at a given angle to the surfaces of the flexure 12. With this arrangement, even in an HSA, the adjustment pins 922 to 925 can be brought into contact with the flexure 12 for bending. In addition, mutual interference, e.g., contact or overlap of the driving units 932 to 935, can be avoided even if the magnetic head 2 and the flexure 12 are miniaturized.

<Laser Emitter Unit>

FIG. 7 is a diagram showing arrangement of the laser emitter units 911, 912. The laser emitter units 911, 912 irradiate laser beams LA to the flexure 12 (see FIG. 1). As the laser emitter units 911, 912, there may be employed a variety of types of lasers including a YAG laser. The illustrated laser emitter unit 911, 912 are directed toward bent areas of the flexure 12. Although two laser emitter units 911, 912 are provided in the illustrated embodiment, the number of laser emitter units is arbitrary. In the illustrated embodiment, furthermore, the laser emitter units 911, 912 are inclined at a given angle to the surfaces of the flexure 12. With this inclined arrangement, even in an HSA, the laser beams can be irradiated at an angle to the target areas of the flexure 12 of one HAA without being blocked by the other HAA.

<Computer System>

The computer system 94 comprises a CPU 941 and a memory unit (e.g., ROM) 942 in which adjustment conditions corresponding to static attitude angles of the magnetic head 2 are previously ranked and memorized. The CPU 941 retrieves from the memory unit 942 particular adjustment conditions corresponding to measured values supplied from the image pickup units A to C and supplies the retrieved adjustment conditions to the adjusting unit 92. The adjusting unit 92 bends the flexure 12 based on the adjustment conditions supplied from the computer system 94. The computer system 94 is a program execution unit composed of the CPU 941 and the memory unit, including not only a personal computer and a microcomputer, but also a so-called sequencer unit.

<Static Attitude Adjusting Method >

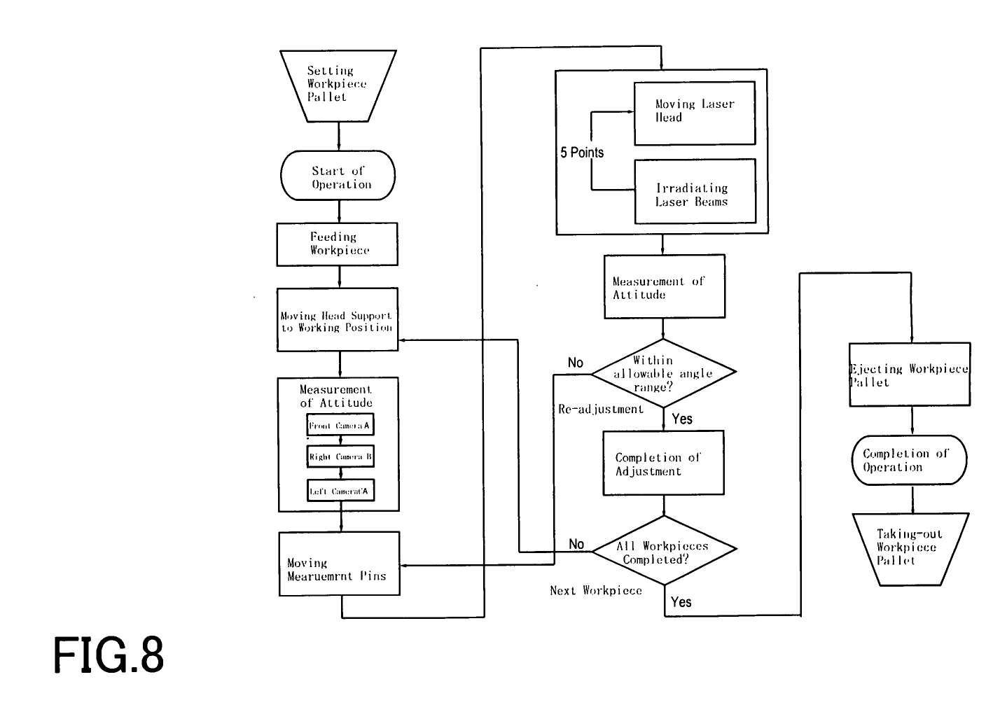

Next, the static attitude adjusting method according to one embodiment of the present invention will be described with reference to FIG. 8 along with the above drawings, particularly FIG. 1. FIG. 8 is a flow chart of the static attitude adjusting method according to one embodiment of the present invention.

At first, through the preparatory stages including setting of workpiece pallet, start of operation, feeding of workpiece pallet, and holding of workpiece, the HSA 95 and the workpiece pallet 971 are mounted on the conveying jig 973 and held against the conveying jig 973 by the holding jig 972, as shown in FIG. 1.

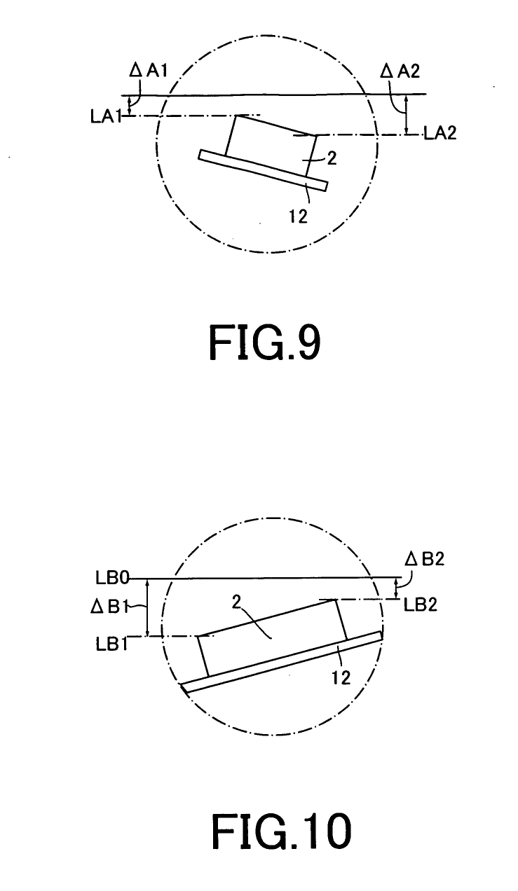

In this state, the static attitude angles of the magnetic head 2 are measured by the image pickup units A to C. Referring now to FIGS. 9 to 12, processes of measuring the static attitude angles of the magnetic head 2 with the use of the image pickup units A to C will be described. An image signal obtained from the first to third image pickup units A to C is supplied to and calculated by the computer system 94. This results in determination of the roll and pitch angles.

At first, the roll angle measuring process will be described with reference to FIG. 9. The roll angle can be determined by analyzing an image signal obtained from the first image pickup unit A. Basically, the roll angle can be determined as an angle which the ABS of the magnetic head 2 makes with the reference line LAO indicating zero roll angle of the ABS in the image signal. More specifically, the roll angle can be determined by analyzing an image signal obtained from the first image pickup unit A to detect a difference between a distance ΔA1 from one edge LA1 of the ABS to the reference line LAO and a distance ΔA2 from the other edge LA2 to the reference line LAO (ΔA1-ΔA2), as shown in FIG. 9.

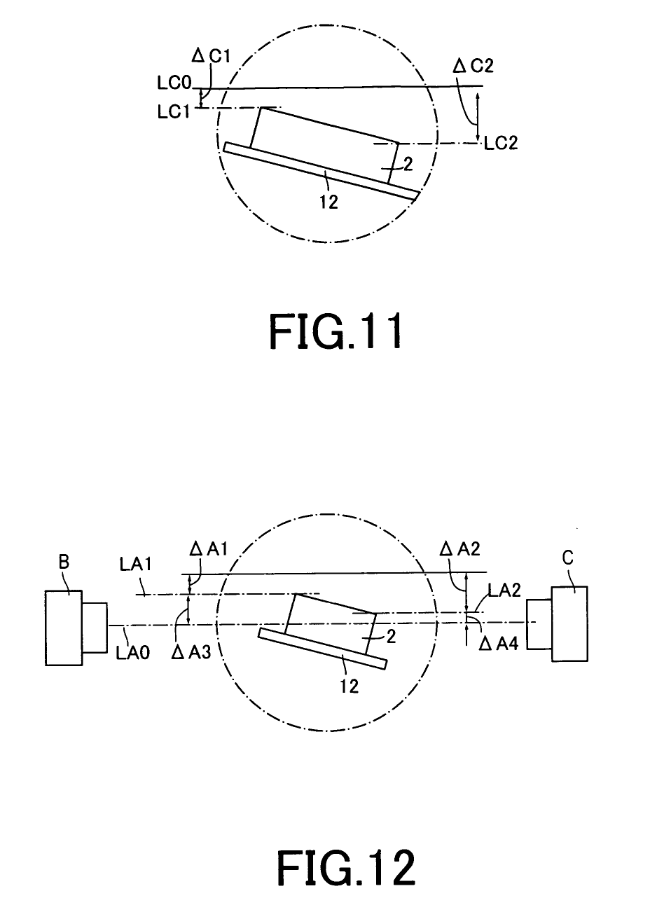

The pitch angle can be determined by analyzing an image signal obtained from the second and third image pickup units B, C. The pitch angle can be determined as an angle which the ABS of the magnetic head 2 makes with the reference lines LBO, LCO indicating zero pitch angle of the ABS in the image signal. In case of the second image pickup unit B, more specifically, the pitch angle can be determined from a difference between a distance ΔB1 from one edge LB1 of the ABS to the reference line LBO and a distance ΔB2 from the other edge LB2 to the reference line LBO(ΔB1-ΔB2), as shown in FIG. 10. In case of the third image pickup unit C, the pitch angle can be determined from a difference between a distance ΔC1 from one edge LC1 of the ABS to the reference line LCO and a distance ΔC2 from the other edge LC2 to the reference line LCO (ΔC1-ΔC2), as shown in FIG. 11.

The roll angle may be determined by analyzing an image signal obtained from the second and third image pickup units B, C, as particularly shown in FIG. 12. Referring to FIG. 12, the roll angle can be determined as an angle which the ABS makes with a reference line LAO connecting calibrated origins of the second and third image pickup units B, C. More specifically, the roll angle can be determined from a difference between a distance ΔA3 from one edge LA1 of the ABS to the calibrated reference line LAO of the second and third image pickup units B, C and a distance ΔA4 from the other edge LA2 to the calibrated reference line LAO (ΔA3-ΔA4).

The CPU 941 of the computer system 94 retrieves from the memory unit 942 particular adjustment conditions corresponding to measured values, e.g., the roll angle (ΔA1-ΔA2) and the pitch angle (ΔB1-ΔB2) and (ΔC1-ΔC2) obtained by analyzing an image signal from the first to third image pickup units A to C, and supplies the retrieved adjustment conditions to the adjusting unit 92. The adjusting unit 92 is operated to move the adjustment pins 922 to 925 based on the adjustment conditions supplied from the computer system 94, thereby bending the flexure 12. The adjustment conditions include contact positions and thrust distances of the adjustment pins 922 to 925 against the flexure 12 and laser irradiation positions on the flexure 12. The adjustment conditions may further include laser irradiation times.

Setting of the adjustment conditions and controlling of movement of the adjustment pins 922 to 925 by the computer system 94 will be described hereinbelow. As described above, the static attitude angles include the pitch and roll angles and may vary depending on the assembled position of the magnetic head 2 relative to the head support 1, the bending of the head support 1, and other conditions. Furthermore, the pitch and roll angles may take positive and negative values with the horizontal position as a reference value 0. Accordingly, the pitch and roll angles have to be adjusted positively or negatively.

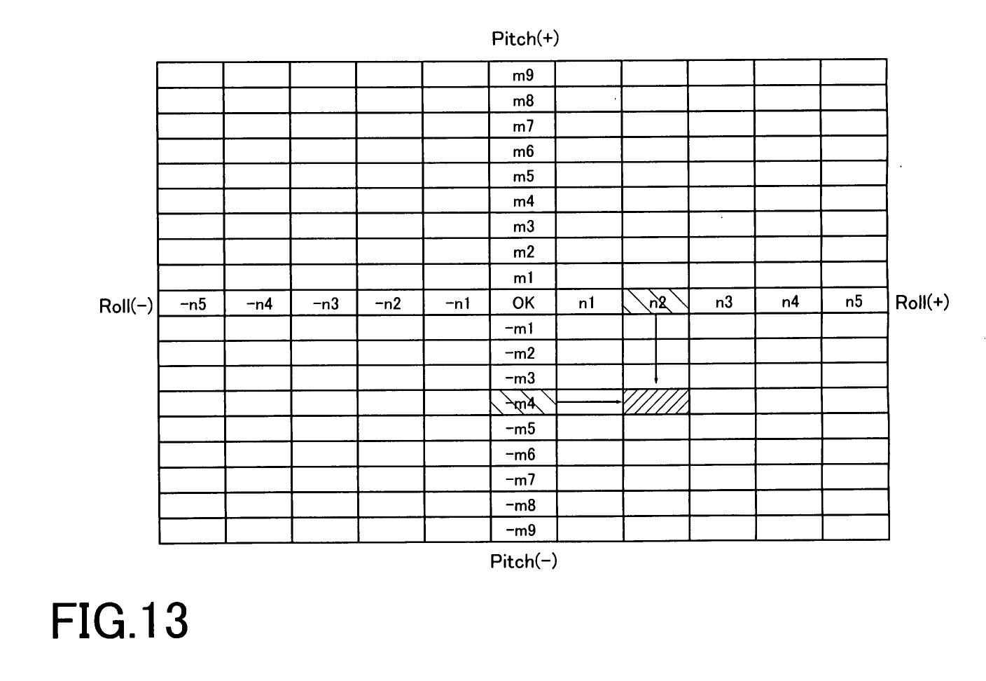

In order to enable such adjustment, the adjustment conditions corresponding to the static attitude angles of the magnetic head 2 are previously ranked and memorized in the memory unit 942. FIG. 13 is a diagram showing its idea, wherein adjustment conditions corresponding to measured pitch angles are ranked along the ordinate, e.g., positive ranks (ml to m9) and negative ranks (−m1 to −m9); adjustment conditions corresponding to measured roll angles are ranked along the abscissa, e.g., positive ranks (n1 to n9) and negative ranks (−n1 to −n9). They are previously memorized in the memory unit 942. It will be appreciated that the number of ranks is arbitrary. When a signal for static attitude angles is supplied from the first to third image pickup units A to C, then, the CPU 941 retrieves from the memory unit 942 particular adjustment conditions corresponding to the measured values and supplies the retrieved adjustment conditions to the adjusting unit 92.

In FIG. 13, for example, the positive rank (n2) and the negative rank (−m4) are retrieved from the memory unit 942, wherein the former is the adjustment condition corresponding to the measured roll angle and the latter is the adjustment condition corresponding to the measured pitch angle.

Based on the adjustment conditions supplied from the computer system 94, the adjusting unit 92 bends the flexure 12 supporting the magnetic head 2. At this time, bending is performed to adjust the roll angle from the positive rank (n2) to the origin point OK and the pitch angle from the negative rank (−m4) to the origin point OK as seen in the diagram of FIG. 13. With such adjustment conditions supplied from the computer system 94 to the adjusting unit 92, the movement of the adjustment pins 922 to 925 is controlled by the adjusting unit 92.

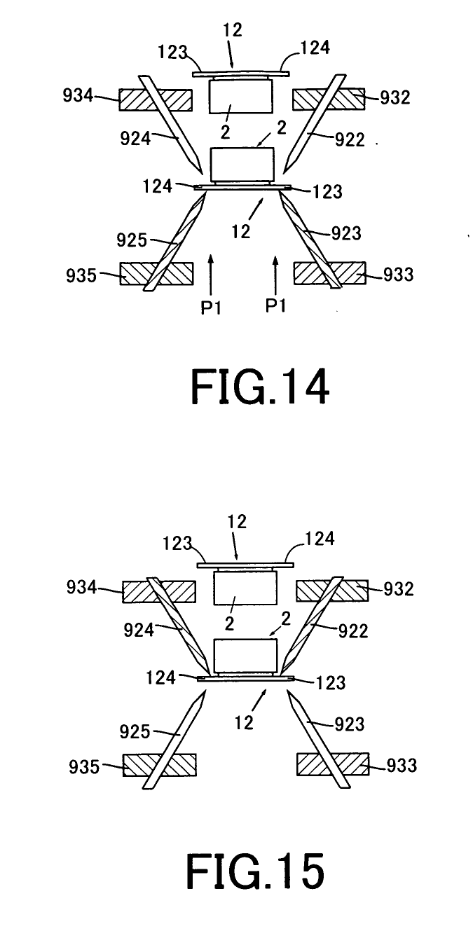

Next, processes of adjusting the static attitude angles with the use of the adjustment pins 922 to 925 will be described in detail. FIGS. 14 and 15 are diagrams showing pitch angle adjusting processes by the adjusting unit 92 shown in FIG. 6. First, as shown in FIG. 14, the adjustment pins 923, 925 are moved linearly in a direction P1 to press with their distal ends the longitudinal frame portions 123, 124 of the flexure 12 for pitch angle adjustment. This pitch angle adjusting direction P1 is taken as a positive direction.

FIG. 15 shows a case of adjusting the pitch angle in a negative direction P2, wherein the adjustment pins 922, 924 are moved linearly in the direction P2 to press with their distal ends the longitudinal frame portions 123, 124 of the flexure 12. Thus, the pitch angle can be adjusted in the negative direction P2.

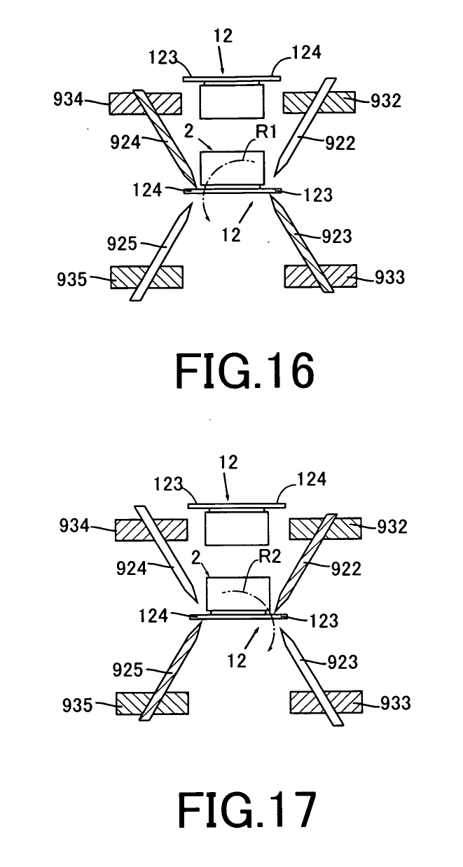

FIGS. 16 and 17 are diagrams showing roll angle adjusting processes by the adjusting unit 92 shown in FIG. 6. First, as shown in FIG. 16, the adjustment pin 923 is moved linearly in the direction P1 to press with its distal end the longitudinal frame portion 123 of the flexure 12, and at the same time, the adjustment pin 924 is moved linearly in the direction P2 to press with its distal end the longitudinal frame portion 124 of the flexure 12. Thus, the roll angle can be adjusted in a direction R1. This roll angle adjusting direction R1 is taken as a positive direction.

FIG. 17 shows a case of adjusting the roll angle in a negative direction R2, wherein the adjustment pin 922 is moved linearly in the direction P2 to press with its distal end the longitudinal frame portion 123 of the flexure 12, and at the same time, the adjustment pin 925 is moved linearly in the direction P1 to press with its distal end the longitudinal frame portion 124 of the flexure 12. Thus, the roll angle can be adjusted in the negative direction R2.

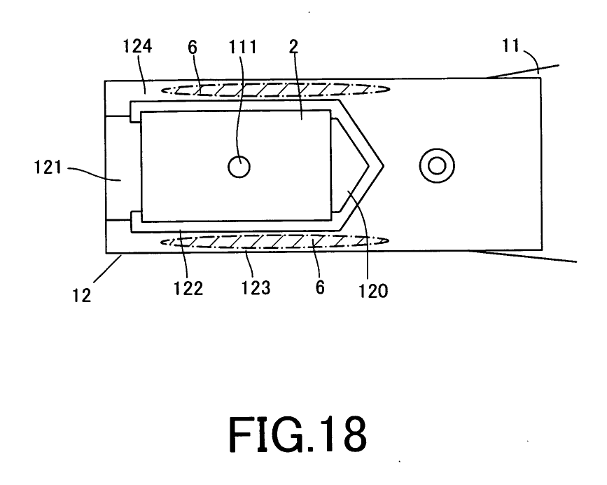

During the processes of adjusting the pitch angle and the roll angle shown in FIGS. 14 to 17, the laser beams LA are irradiated from the laser emitter units 911, 912 to one side of the flexure 12. More specifically, as shown in FIG. 18, the laser beams LA are irradiated to bent areas 6 of the flexure 12. The term “bent area” as used herein refers to an area where a flexure is bent for static attitude adjustment. The laser beams LA may be irradiated not to one point but to a plurality of points (e. g., 10 points) spaced apart over a distance. The laser beams LA may be irradiated to the other side of the flexure 12.

When the flexure 12 is mechanically bent in the processes illustrated in and described with reference to FIGS. 14 to 17, a stress corresponding to the bending is generated in the flexure 12. According to one embodiment of the present invention, since the laser beams LA are irradiated to the bent areas 6 of the flexure 12, the stress in the laser-irradiated areas 6 can be relieved by heat due to the irradiation of the laser beams LA. As a result, the restoring effect of the flexure 12 decreases in the laser-irradiated areas 6, keeping the flexure 12 bent at an angle close to the initial bending angle. This means that the flexure 12 can be kept at a desired bending angle even if the initial bending angle is small. If the areas 6 of the flexure 12 to be exposed to the laser beams LA are made of stainless steel, the laser beams LA are preferably irradiated to increase their surface temperature, for example, to 300 to 400° C. while blowing N₂ thereto.

Thus, a significant change in static attitude can be obtained from bending the flexure 12 at a small angle. The above static attitude adjusting apparatus, which provides a static attitude adjusting system mainly of the CPU 941, enables automatic adjustment of the static attitude of the magnetic head 2 with a high degree of reliability.

After adjusting the static attitude of the magnetic head 2 as described above, the static attitude angles of the magnetic head 2 are again detected by the first to third image pickup units A to C to let the CPU 941 of the computer system 94 determine whether the detected static attitude angles fall within allowable angle ranges (which correspond to the origin point OK in FIG. 13). As a result of determination, if the detected static attitude angles do not fall within allowable angle ranges, the CPU 941 of the computer system 94 again supplies particular adjustment conditions to the adjusting unit 92. The adjusting unit 92 is operated to move the adjustment pins 922 to 925 based on the adjustment conditions supplied from the computer system 94, thereby bending the flexure 12. Then, the laser emitter units 911, 912 irradiate the laser beams LA to the bent areas of the flexure 12.

The above processes of detecting the static attitude angles, moving the adjustment pins, and irradiating the laser beams are repeated until the adjustment conditions for the roll and pitch angles come to the origin point OK shown in FIG. 13. When it is determined that the detected static attitude angles fall within allowable angle ranges (which correspond to the origin point OK in FIG. 13), then, the adjustment is completed. Subsequently, processing of a next workpiece (or another HSA 95) starts to execute the above processes. After completion of processing of all the set workpieces, the workpiece pallet is ejected, the operation is completed, and the workpiece pallet is taken out.

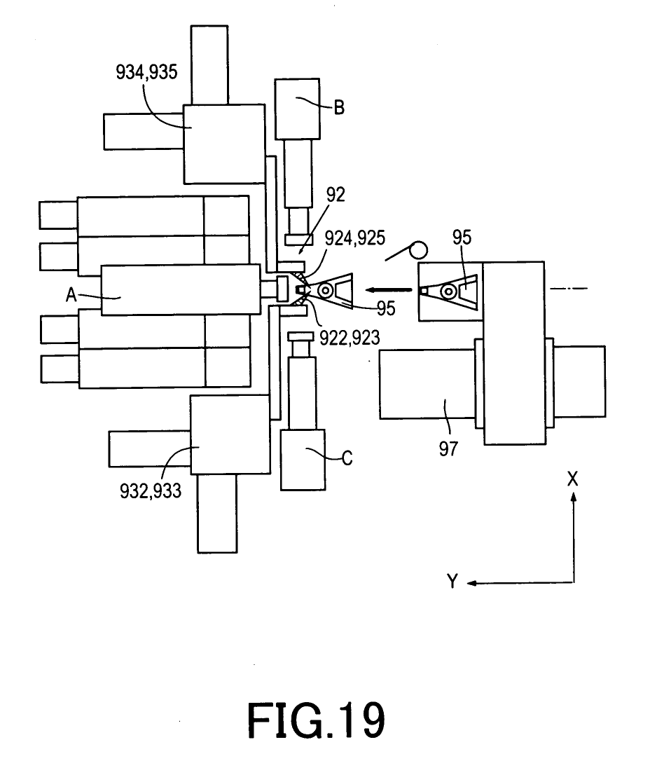

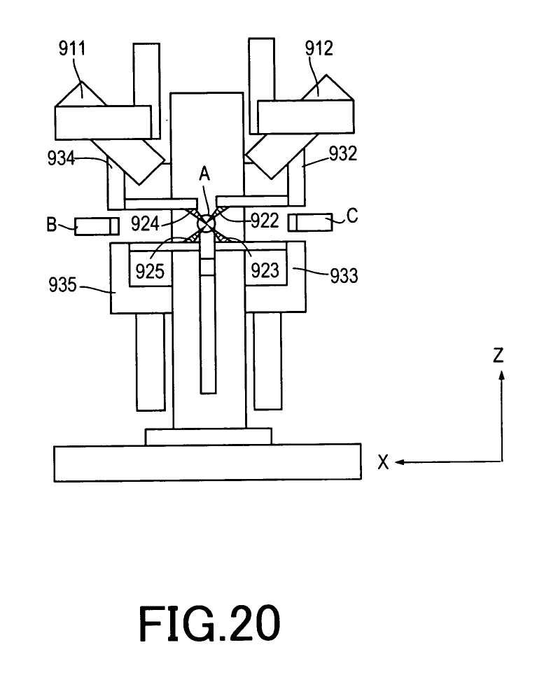

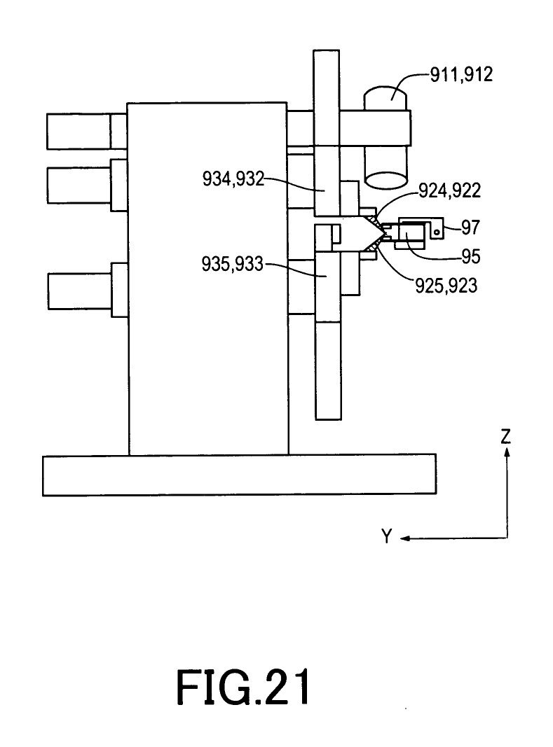

FIG. 19 is a plan view showing a concrete structure of a static attitude adjusting apparatus according to one embodiment of the present invention, FIG. 20 is a front view of the static attitude adjusting apparatus shown in FIG. 19, and FIG. 21 is a side view of the static attitude adjusting apparatus shown in FIGS. 19 and 20. In these drawings, only the mechanical parts are illustrated and the portions corresponding to the components shown in the above drawings are designated by the same reference symbols.

The laser emitter units 911, 912 have three perpendicular axes X, Y and Z and is provided with an X-Y table capable of moving along the X axis (or lateral direction) and the Y axis (or depth direction).

The adjusting unit 92 includes the four adjustment pins 922 to 925 and the four driving units 932 to 935. These adjustment pins 922 to 925 are each disposed at an inclined position and driven to move along the Y axis and the Z axis by the driving units 932 to 935 while being kept at the inclined position.

The first to third image pickup units A to C are composed of a CCD camera and movable along the X, Y, Z axes and about the X, Y axes (θX, θY) for position adjustment.

The HSA 95 being a workpiece is supported by the workpiece pallet 971, the holding jig 972 and the conveying jig 973 (see FIG. 1) and fed to a position where the magnetic head 2 can be pressed by the adjustment pins 922 to 925, exposed to the laser beams irradiated from the laser emitter units 911, 912, and measured for static attitude by the first to third image pickup units A to C.

The static attitude adjusting apparatus illustrated in FIGS. 19 and 21 can automatically execute the static attitude adjustment described with reference to FIGS. 1 to 18 with a high degree of efficiency.

While the present invention has been particularly shown and described with reference to embodiments thereof, it will be understood by those skilled in the art that various changes in form and detail may be made therein without departing from the spirit, scope and teaching of the invention. For example, the adjusting unit 92 is not be limited to the type using the pins but may be of the type of bending the flexure 12 by clamping.

What is claimed is:

1. A method for adjusting static attitude of a magnetic head attached to a flexure that is disposed near a free end of a head support, the free end being a distal end in a longitudinal direction of the head support, the method comprising:
generating an adjustment condition by analyzing an image signal obtained from images of the magnetic head, the images being picked up with at least two image pickup units;
bending the flexure for static attitude adjustment based on the adjustment condition; and
irradiating a laser beam to a bent area of the flexure.

2. The method of claim 1, wherein the adjustment condition is generated by analyzing an image signal obtained from two images of the magnetic head,
wherein one image is picked up from a front side facing the free end, and another image is picked up from a lateral side in a direction approximately perpendicular to the longitudinal direction.

3. The method of claim 1, wherein the adjustment condition is generated by analyzing an image signal from three images of the magnetic head,
wherein one image is picked up from a front side facing the free end, and the other two images are picked up from both lateral sides in a direction approximately perpendicular to the longitudinal direction.

4. The method of claim 1, wherein the adjustment condition is generated by analyzing an image signal from two images of the magnetic head,
wherein the two images are picked up from both lateral sides in a direction approximately perpendicular to the longitudinal direction.

5. The method of claim 1, wherein a static attitude angle is determined from an angle which an air bearing surface of the magnetic head makes with a reference line indicating zero inclination angle of the air bearing surface.

6. The method of claim 5, wherein a static attitude angle is determined from a difference in distance between the reference line and two edges of the air bearing surface.

7. An apparatus for adjusting static attitude of a magnetic head attached to a flexure that is disposed near a free end of a head support, the free end being a distal end in a longitudinal direction of the head support, the apparatus comprising:
an adjusting unit for bending the flexure;
a laser emitter unit for irradiating a laser beam to a bent area of the flexure;
at least two image pickup units for picking up images of the magnetic head to generate an image signal; and
a computer system for analyzing the image signal supplied from the image pickup units to generate an adjustment condition, enabling the adjusting unit to bend the flexure based on the adjustment condition supplied from the computer system.

8. The apparatus of claim 7, wherein the image pickup units include first and second image pickup units,
wherein the first image pickup unit is located to pick up an image of the magnetic head from a front side facing the free end, and the second image pickup unit is located to pick up an image of the magnetic head from a lateral side in a direction approximately perpendicular to the longitudinal direction.

9. The apparatus of claim 8, wherein the image pickup units further include a third image pickup unit which is located opposite to the second image pickup unit to pick up an image of the magnetic head from another lateral side.

10. The apparatus of claim 7, wherein the image pickup units include two image pickup units which are located to pick up images of the magnetic head from both lateral sides in a direction approximately perpendicular to the longitudinal direction.

11. The apparatus of claim 7, wherein the computer system includes a CPU and a memory unit in which adjustment conditions corresponding to static attitude angles of the magnetic head are previously ranked and memorized,
wherein the CPU is configured to retrieve from the memory unit a particular adjustment condition corresponding to a measured value supplied from the image pickup units and supply the retrieved adjustment condition to the adjusting unit.

12. The apparatus of claim 7, wherein the computer system is configured to determine a static attitude angle from an angle which an air bearing surface of the magnetic head makes with a reference line indicating zero inclination angle of the air bearing surface.

13. The method of claim 12, wherein the computer system is configured to determine a static attitude angle from a difference in distance between the reference line and two edges of the air bearing surface.

14. The apparatus of claim 7, wherein the adjusting unit includes a plurality of movable adjustment pins whose distal ends are positioned to be able to be pressed against surfaces of the flexure, and
the adjustment condition includes contact positions and thrust distances of the adjustment pins against the flexure and laser irradiation positions on the flexure.

15. The apparatus of claim 14, wherein the adjustment pins are disposed at a given angle with respect to the surfaces of the flexure.
